(19) United States
(12) Patent Application Publication
(10) Pub. No.: US 2014/0378103 A1
(43) Pub. Date: Dec. 25, 2014

(54) ARCHIVING A DELIVERY STATUS FOR A TEXT MESSAGE

(71) Applicant: Alcatel-Lucent USA Inc., Marray Hill, NJ (US)

(72) Inventors: Yigang Cai, Naperville, IL (US); Suzann Hua, Lisle, IL (US)

(21) Appl. No.: 13/926,746

(22) Filed: Jun. 25, 2013

(51) Int. Cl. H04W 4/14

(52) U.S. Cl. CPC H04W 4/14
USPC 455/412.2

(57) ABSTRACT

Systems and methods for archiving a delivery status of a text message in addition to the text message itself. In one embodiment, a message center receives a text message, and attempts delivery of the text message to a recipient. The message center generates a copy of the text message, and sends the copy of the text message to an archive center for archiving. The message center also identifies a delivery status of the text message, and sends the delivery status to the archive center for archiving in addition to the copy of the text message.

### FIELD OF THE INVENTION

The invention is related to the field of communications and, in particular, to text messaging.

### BACKGROUND

Text messaging has become popular in many mobile (or wireless) networks. One example of text messaging is Short Message Service (SMS), which is a set of communication protocols allowing the exchange of short text messages (e.g., 160 characters or less) between devices. While the term “text message” traditionally referred to text-only messages sent using SMS, it has been extended to include multimedia messages, such as images, video, sound content, etc. The multimedia messages may be sent using Multimedia Message Service (MMS) protocol.

A sender of a new text message enters one or more intended destinations for the message in a user device (e.g., a phone), and also enters the content of the message. The user device of the sender formats the text message into the proper protocol, and sends the text message to a message center in the network over the appropriate signaling channels where the message is stored and queued for delivery to its intended recipient. One example of a typical message center is an SMS Center (SMSC).

### SUMMARY

Embodiments described herein archive a delivery status of a text message along with the text message itself In instances where a message center, such as an SMSC, sends a copy of a text message to an archive center for archiving, the message center may also identify a delivery status of the text message and send the delivery status to the archive center for archiving. The archive center may therefore archive the delivery status along with the text message. Thus, if the text message is retrieved at a later time, the archive center can also provide information on the delivery status of the text message to the requesting party.

One embodiment comprises a message center configured to receive a text message, and to attempt delivery of the text message to a recipient. The message center is configured to generate a copy of the text message, and to send the copy of the text message to an archive center for archiving. The message center is configured to identify a delivery status of the text message, and to send the delivery status to the archive center for archiving in addition to the copy of the text message.

In one embodiment, the delivery status indicates a success or failure of the delivery attempt for the text message.

In one embodiment, the message center is configured to identify a delivery time for the text message, and to send an indication of the delivery time to the archive center for archiving in addition to the copy of the text message.

In one embodiment, the message center is configured to include a message identifier (ID) for the text message with the delivery status.

In one embodiment, the message center is configured to send the delivery status to the archive center in response to receiving a delivery acknowledgement for the text message.

In one embodiment, the message center is configured to process criteria, such as content of the text message, to determine whether to send the delivery status to the archive center.

In one embodiment, the text message comprises a Short Messaging Service (SMS) message, and the message center comprises an SMS-Center (SMSC).

Another embodiment comprises a method of archiving data for a text message. The method includes receiving a text message in a message center, and attempting delivery of the text message to a recipient. The method further includes generating a copy of the text message, and sending the copy of the text message to an archive center for archiving. The method further includes identifying a delivery status of the text message, and sending the delivery status to the archive center for archiving in addition to the copy of the text message.

In another embodiment, the method further comprises identifying a delivery time for the text message, and sending an indication of the delivery time to the archive center for archiving in addition to the copy of the text message.

In another embodiment, the method further comprises including a message identifier (ID) for the text message with the delivery status.

In another embodiment, the step of sending the delivery status to the archive center further comprises sending the delivery status to the archive center in response to receiving a delivery acknowledgement for the text message.

In another embodiment, the method further comprises processing criteria, such as content of the text message, to determine whether to send the delivery status to the archive center.

In another embodiment, an archive center is configured to receive a copy of a text message from a message center that is involved in delivery of the text message to a recipient, and to archive the copy of the text message. The archive center is configured to receive a delivery status of the text message from the message center, and to archive the delivery status of the text message in addition to the copy of the text message.

In another embodiment, the archive center is configured to receive an indication of a delivery time of the text message, and to archive the indication of the delivery time of the text message in addition to the copy of the text message.

In another embodiment, the archive center is configured to receive a message identifier along with the delivery status, and to correlate the delivery status with the copy of the text message based on the message identifier.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication network in an exemplary embodiment.

FIG. 2 is a flow chart illustrating a method of archiving a delivery status for a text message in an exemplary embodiment.

FIG. 3 is a flow chart illustrating a method of archiving a delivery status for a text message in an exemplary embodiment.

FIG. 4 illustrates a communication system for delivering an SMS message in an exemplary embodiment.

FIG. 5 is a message diagram for archiving a delivery status for a Mobile Terminated (MT) SMS message in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

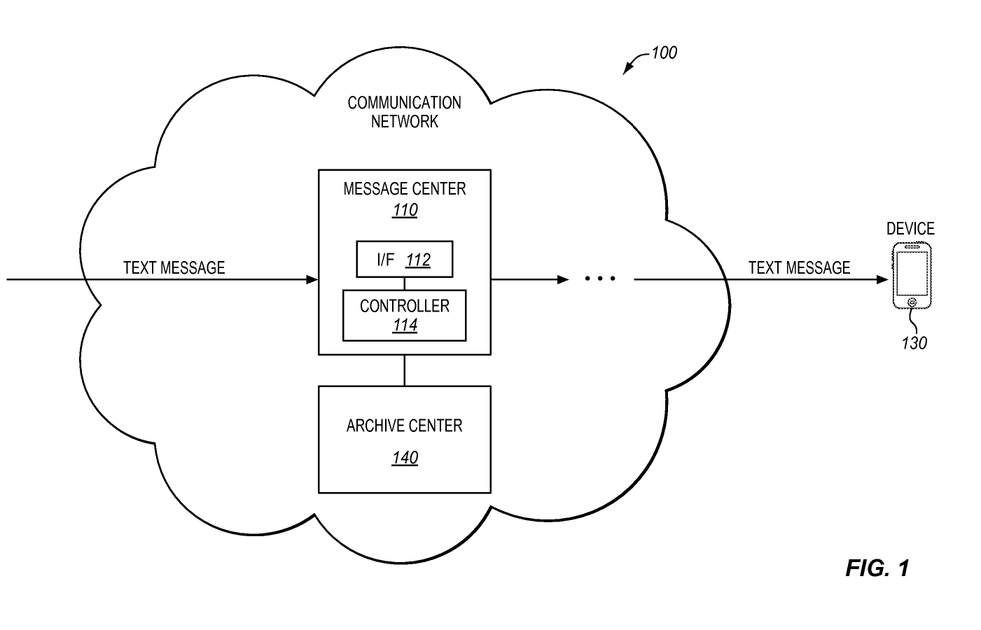

FIG. 1 illustrates a communication network 100 in an exemplary embodiment. Communication network 100 comprises any network that provides communication services to end user devices. Network 100 may comprise a Global System for Mobile

Communications (GSM) network, a Universal Mobile Telecommunications System (UMTS) network, a CDMA2000 network, a Long Term Evolution (LTE) network, an IP Multimedia Subsystem (IMS) network, etc. In this embodiment, network 100 provides a text messaging service to its end users. To implement the text messaging service, network 100 includes a message center 110. Message center 110 comprises any node or network element that handles or facilitates delivery of text messages. Message center 110 may include First Delivery Attempt (FDA) functionality and/or store-and-forward (SNF) functionality to attempt delivery of text messages to their destinations. Some examples of message center 110 include a SMS Center (SMSC), an MMS Center (MMSC), an IP-SM-GW, an SM-IC-GW, an LTE-SM-GW, etc.

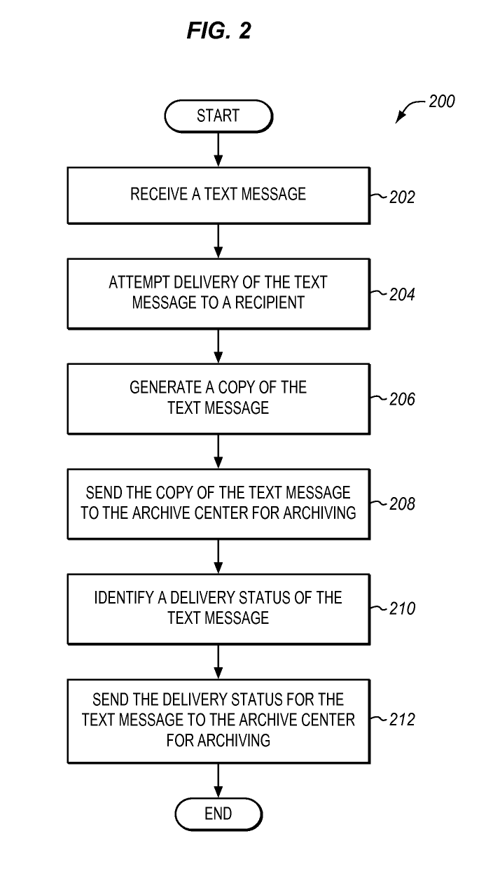

Message center 110 includes an interface (I/F) 112 and a controller 114. Interface 112 comprises any device, component, or module that is able to send and receive text messages according to a signaling protocol. For example, the signaling protocol may comprise Mobile Application Part (MAP) protocol, Session Initiation Protocol (SIP), Short Message Peer-to-Peer (SMPP) protocol, etc. Controller 114 comprises any device, component, or module that controls the operation of message center 110 to facilitate delivery of text messages to destinations. In this embodiment, message center 110 is enhanced (such as through controller 114) to archive data regarding text messages that are delivered over network 100. More particularly, message center 110 is able to send data regarding text messages and send data regarding the delivery status of text messages to a database for storage. To store data related to text messages, network 100 further includes an archive center 140. Archive center 140 comprises any device, component, or module that is configured to archive data for text messages. An archive of data refers to “long-term” storage or persistent storage of text message data for a configurable time-period, which is separate from the store-and-forward functionality of a message center. The data is stored within archive center 140 in a record or a log for text messages. The records for the text messages can be retrieved at another time by a requesting party. Archive center 140 may be owned/controlled by the network operator of network 100, or may be a third-party server that offers archive services. Although not shown in FIG. 1, archive center 140 may have internal components of an interface, a controller, and a database component. Assume for this embodiment that message center 110 receives a text message that is addressed to a recipient 130. The text message received by message center 110 may be a Mobile Originated (MO) or Application-Originated (AO) message, or may be a Mobile Terminated (MT) or Application-Terminated (AT) message. Message center 110 is enhanced in this embodiment to archive data regarding the text message, which is further illustrated in FIG. 2.

FIG. 2 is a flow chart illustrating a method 200 of archiving a delivery status report for a text message in an exemplary embodiment. The steps of method 200 will be described with reference to message center 110 in FIG. 1, but those skilled in the art will appreciate that methods described herein may be performed in other systems. The steps of the flow charts described herein are not all inclusive and may include other steps not shown. The steps may also be performed in an alternative order.

In step 202, message center 110 (through interface 112) receives a text message that is addressed to recipient 130. In step 204, message center 110 (through controller 114) attempts delivery of the text message to recipient 130. To attempt delivery, message center 110 may implement FDA processing or SNF processing to route the text message through network 100 to recipient 130. This may entail routing the text message to another message center (not shown in FIG. 1), to a gateway, to a serving network element (e.g., MSC or S-CSCF) of recipient 130, etc.

Message center 110 may also determine that text message is to be archived. To archive data for the text message, message center 110 generates a copy or duplicate of the text message in step 206. The copy of the text message includes the content (i.e., payload) of the text message. Message center 110 then sends the copy of the text message to archive center 140 for archiving in step 208.

After the delivery attempt of the text message occurs, message center 110 receives a delivery acknowledgement for the text message. The delivery acknowledgement indicates status information for the delivery of the text message. For example, the delivery status may indicate “success” or “failed”. Therefore, message center 110 identifies the delivery status of the text message based on the delivery acknowledgement in step 210. Message center 110 then sends the delivery status for the text message to archive center 140 for archiving in step 212. Message center 110 may also identify a delivery time (e.g., a timestamp) for delivery of the text message in step 210, and send an indication of the delivery time to archive center 140 in step 212.

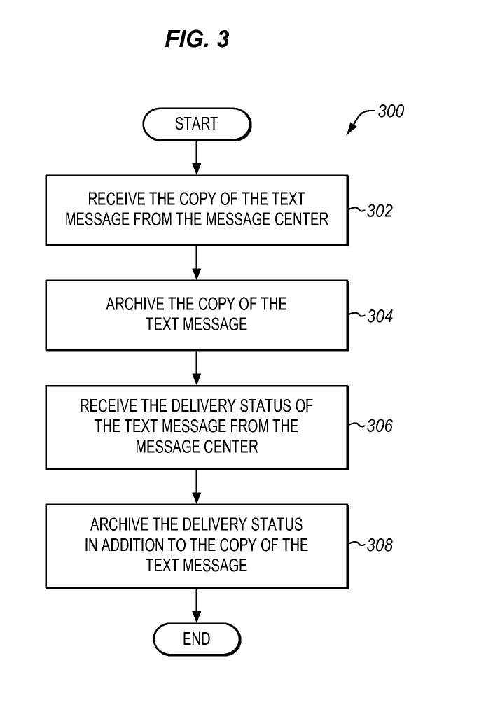

Based on the information provided to archive center 140 from message center 110, archive center 140 is able to store both the copy of the text message and information regarding the delivery status of the text message, which is further illustrated in FIG. 3.

FIG. 3 is a flow chart illustrating a method 300 of archiving a delivery status for a text message in an exemplary embodiment. The steps of method 300 will be described with reference to archive center 140 in FIG. 1, but those skilled in the art will appreciate that methods described herein may be performed in other systems.

In step 302, archive center 140 receives the copy of the text message from message center 110. In response to receiving the copy of the text message, archive center 140 archives the copy of the text message (in step 304). For example, archive center 140 may generate a database entry or record for the text message, and store the copy of the text message in the database entry. The database entry may be indexed by a message identifier (ID) or some other information that uniquely identifies the text message.

In step 306, archive center 140 receives the delivery status of the text message from message center 110. Archive center 140 then archives the delivery status in step 308 in addition to the copy of the text message that is archived. To archive the delivery status, archive center 140 correlates the delivery status with the copy of the text message that is already archived. For example, message center 110 may provide the delivery status to archive center 140 in an archive request that includes a message ID or a correlation ID. Archive center 140 may then locate the database entry for the text message based on the message ID or correlation ID to “correlate” the text message with its delivery status. After correlation, archive center 140 may update the database entry for the archived text message with the delivery status (and delivery time).

With the text message and the delivery status archived, this information may be retrieved at another time by an entity, such as a subscriber, the network operator, a governmental agency, etc. When the entity requests the copy of the text message, archive center 140 may also provide the delivery status (and delivery time) along with the copy of the text message. Thus, the requesting entity will have information about the delivery of the text message instead of just a copy of the text message itself.

Before sending the delivery status of the text message to archive center 140, message center 110 may process rules or criteria to determine whether to archive the delivery status for this text message. Status information may not be archived for every text message that is handled by message center 110. For example, a delivery status may be archived for SMS messages that relate to financial transactions, health/medical, etc. Therefore, the subscribers (i.e., end users) or the network operator may provision rules or criteria that define whether or not to archive a delivery status and/or delivery time for a text message based on conditions, such as:
Archive center destination;
SMS Teleservice ID;
Message content (e.g., financial);
Service type;
SMS class (e.g., ems_class);
Originator of text message;
Recipient of the text message;
Recipient network type;
Incoming and outgoing SMS protocols;
EMS with last segment delivered;
SMS data coding;
Language indicator;
Privacy indicator;
Time of Day (ToD), Day of the Week (DoW);
Others.
   Message center 110 may then process these policy rules to determine whether or not to provide a delivery status for a particular text message to archive center 140.

### EXAMPLE

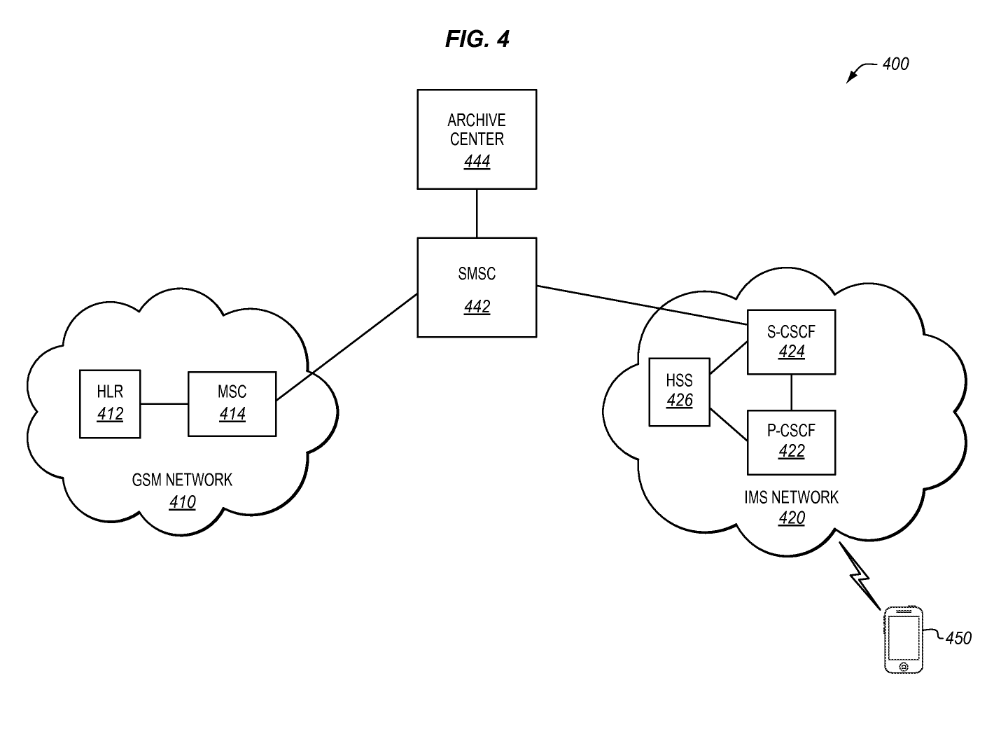

FIG. 4 illustrates a communication system 400 for delivering an SMS message in an exemplary embodiment. Communication system 400 includes multiple communication networks, which are illustrated as GSM network 410 and IMS network 420 in this embodiment. GSM network 410 includes a Home Location Register (HLR) 412 and a Mobile Switching Center (MSC) 414. HLR 412 is a central subscriber database that stores subscription information and other details (e.g., subscriber profiles) of mobile devices that are authorized to use GSM network 410. MSC 414 is the serving node for mobile devices, and is responsible for handling voice calls, SMS, and other services in GSM network 410.

IMS network 420 includes Proxy-Call Session Control Function (P-CSCF) 422, a Serving-Call Session Control Function (S-CSCF) 424, and a Home Subscriber Server (HSS) 426. P-CSCF 422 is the entry point to the IMS domain and serves as the outbound proxy server for IMS devices (User Equipment (UE)). S-CSCF 424 is the central node of the signaling plane, and performs session control for IMS devices that initiate sessions over IMS network 420. S-CSCF 424 communicates with IMS devices over one or more access networks that are not shown in FIG. 4. HSS 426 is a subscriber server that stores subscription-related information (e.g., subscriber profiles), performs authentication and authorization of end users, provides information about the subscriber's location, etc. In this embodiment, IMS network 420 serves UE 450.

Communication system 400 also includes SMS Center (SMSC) 442 and an archive center 444. SMSC 442 comprises any node that delivers SMS messages using store-and-forward processing. SMSC 442 also includes SMS gateway functionalities to interwork signaling between networks that use a different signaling protocol. For example, if a network or device uses Short Message Peer-to-Peer (SMPP) protocol to exchange SMS messages, then SMSC 442 is able to interwork the SMPP protocol messages to SIP and vice-versa. Archive center 444 is a node configured to archive SMS messages that are handled by SMSC 442.

Assume for this embodiment that SMSC 442 handles an SMS message that is intended for UE 450. The following embodiment illustrates how a delivery status report is archived for the SMS message in addition to the SMS message itself.

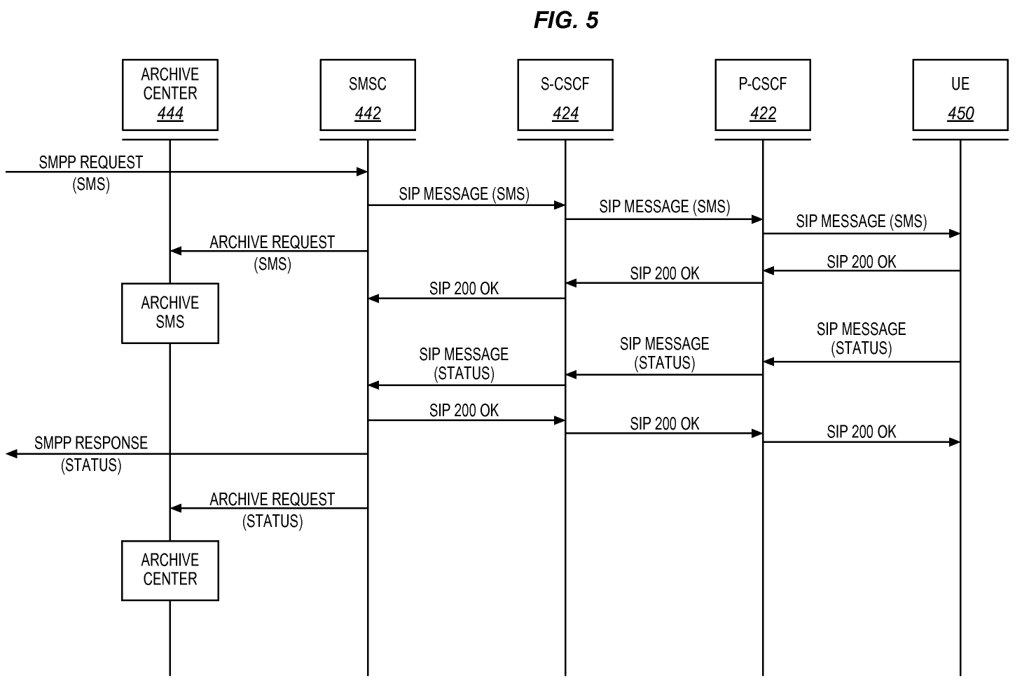

FIG. 5 is a message diagram for archiving a delivery status for a Mobile Terminated (MT) SMS message in an exemplary embodiment. To begin, SMSC 442 receives the SMS message from GSM network 410 that is intended for UE 450 (the SMS message originated in GSM network 410). For example, the SMS message may originate in an enterprise application, such as a bank, which sends an AO SMS message to SMSC 442 regarding a financial transaction for a user of UE 450. The SMS message received by SMSC 442 is encapsulated in SMPP message (e.g., data_sm message). In response to the SMS message, SMSC 442 temporarily stores the SMS message for SNF processing. SMSC 442 also attempts delivery of the SMS message to UE 450. To do so, SMSC 442 constructs a SIP MESSAGE that encapsulates the SMS message. SMSC 442 then routes the SIP MESSAGE to S-CSCF 424 in IMS network 420, and S-CSCF 424 in turn routes the SIP MESSAGE to UE 450 through P-CSCF 422.

SMSC 442 also determines whether message archiving applies for this SMS message. If so, SMSC 442 makes a copy of the SMS message for archiving, and sends the copy of the SMS message to archive center 444 in an archive request. When archive center 444 receives the initial request from SMSC 442 to archive the SMS message, archive center 444 stores the copy of the SMS message with a delivery status of “unknown”.

When UE 450 receives the SIP MESSAGE, UE 450 responds with a SIP 200 OK acknowledging receipt of the SIP MESSAGE. UE 450 (through its SMS application) also attempts to parse the SMS message in the SIP MESSAGE, and is able to generate status information regarding the delivery of the SMS message, such as a “read” acknowledgement. For instance, if the SMS message is successfully received or opened by the SMS application of UE 450, then UE 450 is able to generate status information indicating a successful result. If the SMS message is not successfully received or opened by the SMS application of UE 450, then UE 450 is able to generate status information indicating an unsuccessful or failed result. After generating the status information, UE 450 generates a SIP MESSAGE that includes the status information, and sends the SIP MESSAGE to S-CSCF 424 (through P-CSCF 422). S-CSCF 424 then forwards the SIP MESSAGE to SMSC 442.

In response to the SIP MESSAGE from UE 450, SMSC 442 generates an SMPP response and maps the status information from the SIP MESSAGE to the SMPP response. SMSC 442 then sends the SMPP response to GSM network 410 (where the SMS message originated).

SMSC 442 also determines whether archiving applies for the status information for the SMS message. SMSC 442 may process policy rules or criteria to determine whether to archive a delivery status for the SMS message. Assume for this example that the SMS message relates to a financial transaction, and SMSC 442 determines that a delivery status should be archived for this SMS message. SMSC 442 then sends another archive request to archive center 444 that includes a delivery status (e.g., “success” or “failure”) for the SMS message. The archive request also indicates a delivery time of the SMS message. SMSC 442 also inserts a message ID or correlation ID into the archive request. If SMSC 442 is handling the MT part of the SMS message, then SMSC 442 may insert the message ID for the MT SMS message in the archive request for the delivery status. If SMSC 442 is handling both the MO and MT part of the SMS message, then SMSC 442 may include both message IDs for MO and MT in the archive request for the delivery status.

When archive center 444 receives the subsequent request from SMSC 442 to archive the delivery status, archive center 444 processes the message ID(s) from the archive request to correlate the delivery status with the SMS message that is already archived. After the archived SMS message is identified, archive center 444 updates the delivery status and delivery time for the SMS message based on the information contained in the subsequent archive request. Thus, archive center 444 stores the delivery status information for the targeted SMS message, which includes both a delivery status and a delivery time.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A system comprising:
a message center including a processor configured to receive a text message, and to attempt delivery of the text message to a recipient;
the message center is configured to generate a copy of the text message, and to send the copy of the text message to an archive center for archiving;
the message center is configured to identify a delivery status of the text message, and to send the delivery status to the archive center for archiving in addition to the copy of the text message.

2. The system of claim 1 wherein:
the delivery status indicates a success or failure of the delivery attempt for the text message.

3. The system of claim 1 wherein:
the message center is configured to identify a delivery time for the text message, and to send an indication of the delivery time to the archive center for archiving in addition to the copy of the text message.

4. The system of claim 1 wherein:
the message center is configured to include a message identifier (ID) for the text message with the delivery status.

5. The system of claim 1 wherein:
the message center is configured to send the delivery status to the archive center in response to receiving a delivery acknowledgement for the text message.

6. The system of claim 1 wherein:
the message center is configured to process criteria to determine whether to send the delivery status to the archive center.

7. The system of claim 6 wherein:
the criteria comprise content of the text message.

8. The system of claim 1 wherein:
the text message comprises a Short Messaging Service (SMS) message; and
the message center comprises an SMS-Center (SMSC).

9. A method comprising:
receiving a text message in a message center;
attempting delivery of the text message to a recipient;
generating a copy of the text message;
sending the copy of the text message to an archive center for archiving;
identifying a delivery status of the text message; and
sending the delivery status to the archive center for archiving in addition to the copy of the text message.

10. The method of claim 9 wherein:
the delivery status indicates a success or failure of the delivery attempt for the text message.

11. The method of claim 9 further comprising:
identifying a delivery time for the text message; and
sending an indication of the delivery time to the archive center for archiving in addition to the copy of the text message.

12. The method of claim 9 further comprising:
including a message identifier (ID) for the text message with the delivery status.

13. The method of claim 9 wherein sending the delivery status to the archive center further comprises:
sending the delivery status to the archive center in response to receiving a delivery acknowledgement for the text message.

14. The method of claim 9 further comprising:
processing criteria to determine whether to send the delivery status to the archive center.

15. The method of claim 14 wherein:
the criteria comprise content of the text message.

16. The method of claim 9 wherein:
the text message comprises a Short Messaging Service (SMS) message; and
the message center comprises an SMS-Center (SMSC).

17. A system comprising:
an archive center including a processor configured to receive a copy of a text message from a message center that is involved in delivery of the text message to a recipient, and to archive the copy of the text message;
the archive center is configured to receive a delivery status of the text message from the message center, and to archive the delivery status of the text message in addition to the copy of the text message.

18. The system of claim 17 wherein:
the delivery status indicates a success or failure of the delivery attempt for the text message.

19. The system of claim 17 wherein:
the archive center is configured to receive an indication of a delivery time of the text message, and to archive the indication of the delivery time of the text message in addition to the copy of the text message.

20. The system of claim 17 wherein:
the archive center is configured to receive a message identifier along with the delivery status, and to correlate the delivery status with the copy of the text message based on the message identifier.
